(19) United States
(12) Patent Application Publication
(10) Pub. No.: US 2025/0115096 A1
(43) Pub. Date: Apr. 10, 2025

(54) VEHICLE AIR CONDITIONING APPARATUS

(71) Applicant: HONDA MOTOR CO., LTD., Tokyo (JP)

(72) Inventors: Atsuro KINBARA, Tokyo (JP); Atsushi KOJIMA, Tokyo (JP); Yoshiyuki TAKEUCHI, Tokyo (JP); Eijiro NISHIMURA, Tokyo (JP); Kazuhisa NAKAGAWA, Tokyo (JP); Seitaro SUWA, Tokyo (JP); Yoshinori ISHIMOTO, Tokyo (JP)

(21) Appl. No.: 18/909,179

(22) Filed: Oct. 8, 2024

(30) Foreign Application Priority Data
Oct. 8, 2023 (CN) 202311291014.9

(51) Int. Cl. B60H 1/02; B60H 1/22

(52) U.S. Cl. CPC B60H 1/02; B60H 2001/2259

(57) ABSTRACT

In a vehicle air conditioning apparatus including a first air conditioning system capable of performing heating operation using a heat pump, a second air conditioning system capable of performing heating operation using a heater, and a controller configured to control at least the first air conditioning system and the second air conditioning system, when a remaining capacity of a battery that supplies power to a motor of a vehicle exceeds a predetermined threshold, the controller performs the heating operation by the second air conditioning system and operates the first air conditioning system in a defrosting mode. When the remaining capacity of the battery exceeds the predetermined threshold during the heating operation by the first air conditioning system, the controller switches from the heating operation by the first air conditioning system to the heating operation by the second air conditioning system.

This application is based on and claims the benefit of priority from Chinese Patent Application No. CN202311291014.9, filed on 8 Oct. 2023, the content of which is incorporated herein by reference.

### BACKGROUND OF THE INVENTION

### Field of the Invention

The present invention relates to a vehicle air conditioning apparatus, and in particular to a vehicle air conditioning apparatus capable of performing effective electricity waste operation processing using existing components.

### Related Art

Conventionally, there has been known a method of, in an electric vehicle or the like that travels by driving a motor with battery power, discarding (consuming) excess electricity using a vehicle air conditioning apparatus that performs cooling, heating, and the like of the vehicle compartment, in order to avoid overcharging of the battery due to regenerative power generation at the time of descending, decelerating, and the like.

Japanese Unexamined Patent Application, Publication No. 2021-154911 discloses such a configuration that, in a vehicle air conditioning apparatus including a first air conditioning system capable of performing heating operation using a heat pump and a second air conditioning system capable of performing heating operation using a heater, when a battery charge amount exceeds a predetermined threshold, excess electricity is discarded by causing the heater of the second air conditioning system to work.

Patent Document 1: Japanese Unexamined Patent Application, Publication No. 2021-154911

### SUMMARY OF THE INVENTION

In the configuration of Japanese Unexamined Patent Application, Publication No. 2021-154911, however, there is a problem that, since the capability to consume excess electricity depends on the performance of the second air conditioning system, the amount of electricity that can be discarded is limited.

An object of the present invention is to solve the above problem of the known art and provide a vehicle air conditioning apparatus capable of enhancing the electricity waste operation capability to consume excess electricity using existing components.

In order to achieve the above object, the present invention has a first feature in which a vehicle air conditioning apparatus includes: a first air conditioning system capable of performing heating operation using a heat pump; a second air conditioning system capable of performing heating operation using a heater; and a controller configured to control at least the first air conditioning system and the second air conditioning system, and in which when a remaining capacity of a battery that supplies power to a motor of a vehicle exceeds a predetermined threshold, the controller performs the heating operation by the second air conditioning system and operates the first air conditioning system in a defrosting mode.

The present invention has a second feature in which, when the remaining capacity of the battery exceeds the predetermined threshold during the heating operation by the first air conditioning system, the controller switches from the heating operation by the first air conditioning system to the heating operation by the second air conditioning system.

The present invention has a third feature in which the defrosting mode is an operation mode in which temperature of an external heat exchanger for air conditioning refrigerant flowing through a flow channel of the first air conditioning system is made higher than outside air temperature, and the air conditioning refrigerant to is cycled in a gaseous state by fixing a heating expansion valve of the first air conditioning system to a predetermined opening degree and driving a compressor.

Furthermore, the present invention has a fourth feature in which the predetermined opening degree of the heating expansion valve in the defrosting mode is a low opening degree close to a closed state.

According to the first feature, in the vehicle air conditioning apparatus including the first air conditioning system capable of performing heating operation using the heat pump, the second air conditioning system capable of performing heating operation using the heater, and the controller configured to control at least the first air conditioning system and the second air conditioning system, when the remaining capacity of the battery that supplies power to the motor of the vehicle exceeds the predetermined threshold, the controller performs the heating operation by the second air conditioning system and operates the first air conditioning system in the defrosting mode. Therefore, it becomes possible to, when the amount of charge of the battery exceeds the predetermined threshold, avoid overcharging of the battery by discarding electricity while performing the heating operation. Furthermore, by not only causing the second air conditioning system including the heater to work but also operating the first air conditioning system including the heat pump in the defrosting mode, it is possible to enhance the electricity waste operation capability of the whole system using the existing components.

According to the second feature, when the remaining capacity of the battery exceeds the predetermined threshold during the heating operation by the first air conditioning system, the controller switches from the heating operation by the first air conditioning system to the heating operation by the second air conditioning system. Therefore, it becomes possible to, when the remaining capacity of the battery is equal to or below the predetermined threshold, save electricity by the energy-efficient heating operation using the heat pump. In other words, it becomes possible to, only when the remaining capacity of the battery exceeds the predetermined threshold, switch to the inefficient operation by the second air conditioning system to enhance the electricity waste operation capability.

According to the third feature, the defrosting mode is an operation mode in which temperature of an external heat exchanger for air conditioning refrigerant flowing through a flow channel of the first air conditioning system is made higher than outside air temperature, and the air conditioning refrigerant is cycled in a gaseous state by fixing a heating expansion valve of the first air conditioning system to a predetermined opening degree and driving a compressor. Therefore, it becomes possible to enhance the electricity waste operation capability using the existing components.

According to the fourth feature, the predetermined opening degree of the heating expansion valve in the defrosting mode is a low opening degree close to a closed state. Therefore, it becomes possible to perform operation in the defrosting mode by way of control similar to control of heating operation.

### BRIEF DESCRIPTION OF THE DRAWINGS

FIG. 1 is an outline diagram of an electric vehicle to which a vehicle air conditioning apparatus according to the present embodiment is applied;

FIG. 2 is a schematic diagram showing a circuit configuration of the vehicle air conditioning apparatus according to the present embodiment;

FIG. 3 is a block diagram showing an overall configuration of the vehicle air conditioning apparatus;

FIG. 4 is a circuit diagram showing a state of heating operation in the case of the remaining capacity of a battery being equal to or below a predetermined threshold;

FIG. 5 is a circuit diagram showing a state of heating operation in the case of the remaining capacity of the battery exceeding the predetermined threshold; and

FIG. 6 is a flowchart showing a flow of electricity waste operation control according to the present embodiment.

### DETAILED DESCRIPTION OF THE INVENTION

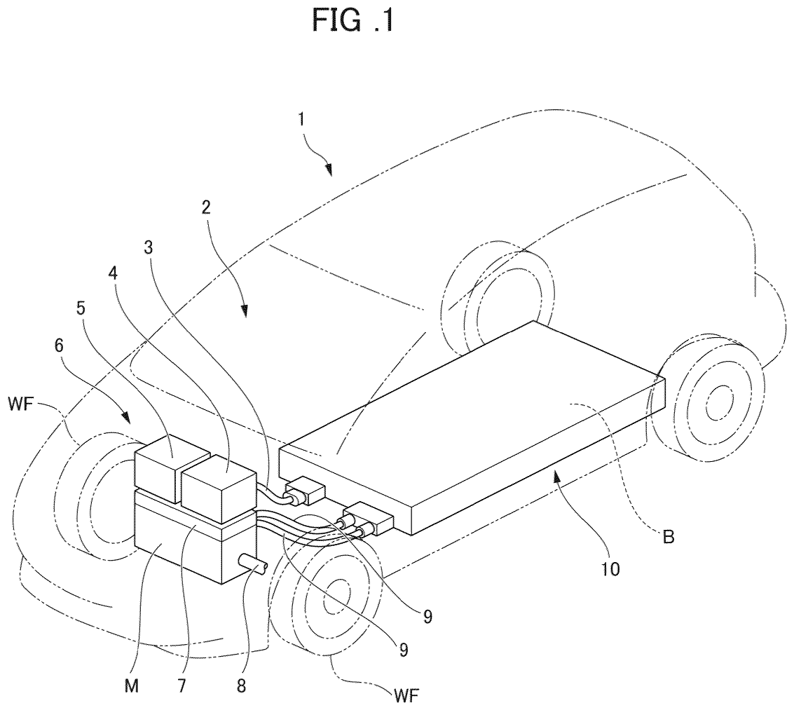

A preferred embodiment of the present invention will be described below in detail with reference to drawings. FIG. 1 is an outline diagram of an electric vehicle 1 to which a vehicle air conditioning apparatus according to the present embodiment is applied. The electric vehicle 1 that drives a motor M with power of a battery B to travel may be a so-called electric automobile including a battery and a motor, a fuel cell vehicle including a power generation system using a fuel cell, or a hybrid vehicle using both of a motor and an internal combustion engine.

In an underfloor part of a vehicle compartment 2 of the electric vehicle 1, a battery case 10 is arranged which houses the battery B including a lithium-ion battery or the like. In a motor room 6 provided at the front of the vehicle body, the motor M, a power converter 7, a brancher 4, and a charger 5 are arranged.

The driving force of the motor M is transmitted to a pair of left and right front wheels WF via a shaft 8. The power converter 7 is fixed to the top of the motor M and is electrically connected to the battery case 10 via a power source cable 9. The power converter 7 performs drive control of the motor M with power supplied from the battery B.

The brancher 4 and the charger 5 are arranged side by side in the vehicle width direction on the top of the power converter 7. The brancher 4 and the battery case 10 are electrically connected via a cable 3 having connectors at both ends.

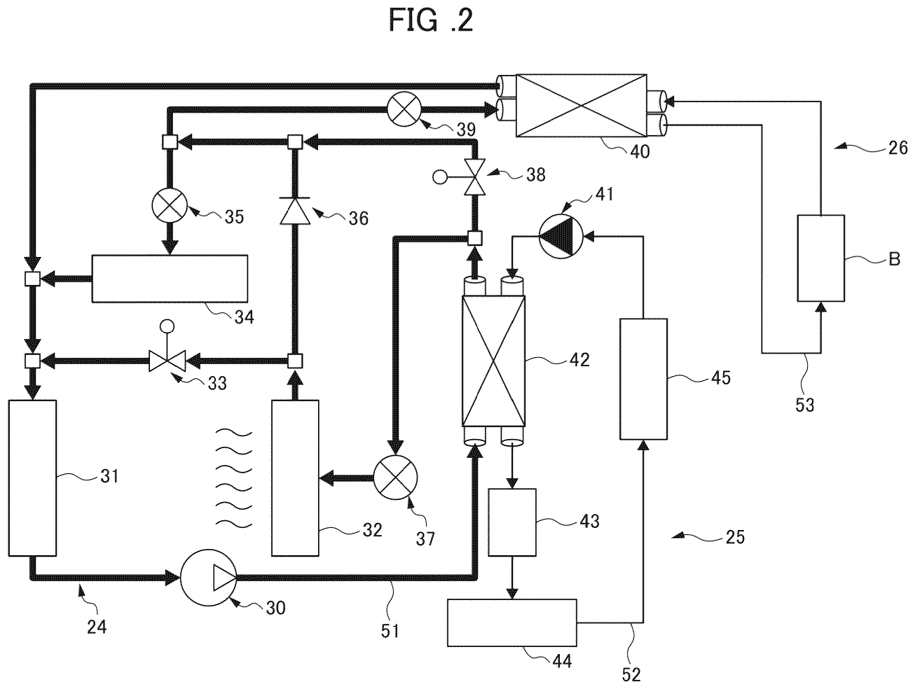

FIG. 2 is a schematic diagram showing a circuit configuration of the vehicle air conditioning apparatus according to the present embodiment. The vehicle air conditioning apparatus includes a heat pump circuit 24 that causes air conditioning refrigerant consisting of refrigerant gas such as R1234yf to circulate, a temperature control circuit 25 that causes a heat transfer medium consisting of water, coolant, or the like to circulate, and a battery temperature control circuit 26 that causes a battery heat transfer medium consisting of water, coolant, or the like to circulate.

A first flow channel 51 constituting the heat pump circuit 24 is provided with a compressor 30 that pumps the air conditioning refrigerant, an external heat exchanger 32, a heating expansion valve 37, a water-cooled condenser 42, a high-pressure solenoid valve 38 that opens and closes the flow channel 51, a check valve 36 that prevents backflow of the air conditioning refrigerant, a cooling expansion valve 35, an evaporator 34 as a heat sink, a low-pressure solenoid valve 33 that opens and closes the flow channel 51, an accumulator 31 as a gas-liquid separator, a battery temperature control expansion valve 39, and a chiller 40 as a heat exchanger.

The evaporator 34 performs heat exchange between the low-temperature air conditioning refrigerant passing through a tube arranged inside the evaporator 34 and air in contact with a heat dissipation fin provided outside the tube. In other words, the air conditioning refrigerant passing through the evaporator 34 evaporates by absorbing heat, thereby cooling the air around it and causing condensation to form on the surface of the heat dissipation fin to perform dehumidification. The accumulator 31 performs gas-liquid separation of the air conditioning refrigerant and supplies only gas-phase air conditioning refrigerant to the compressor 30.

A second flow channel 52 constituting the temperature control circuit 25 as an auxiliary heating system, is provided with a water pump 41 that pumps the heat transfer medium, the water-cooled condenser 42 as an outdoor heat exchanger, a water heater (ECH: electric coolant heater) 43 as a heater that heats the heat transfer medium, a heater core 44 as a radiator, and a reservoir tank 45 that, by temporarily stores the heat transfer medium, absorbs pressure change and flow rate change accompanying thermal expansion. The heater core 44 arranged on the downstream side of the water heater 43 performs heat exchange between the high-temperature heat transfer medium passing through a tube arranged inside the heater core 44 and air in contact with a heat dissipation fin provided outside the tube.

A third flow channel 53 constituting the battery temperature control circuit 26 is provided with the chiller 40 and the battery B provided with a flow channel for a battery heat transfer medium. The chiller 40 has a function of performing heat exchange between the air conditioning refrigerant flowing through the first flow channel 51 and the battery heat transfer medium flowing through the third flow channel 53, and causing the battery heat transfer medium to circulate.

Each of the heating expansion valve 37, the cooling expansion valve 35, and the battery temperature control expansion valve 39 has a function of blowing liquid-phase air conditioning refrigerant in mist at a high pressure and performing decompression so as to facilitate evaporation, and is configured so that the opening degree can be adjusted between fully closed and fully open.

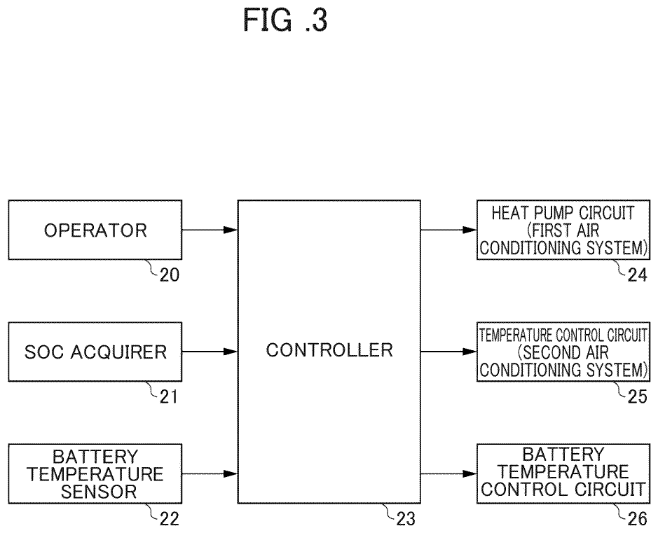

FIG. 3 is a block diagram showing an overall configuration of a vehicle air conditioning apparatus 50. The vehicle air conditioning apparatus 50 includes an operator 20, an SOC acquirer 21, a battery temperature sensor 22, a controller 23, the heat pump circuit 24 as a first air conditioning system, the temperature control circuit 25 as a second air conditioning system, and the battery temperature control circuit 26. The controller 23 including a microcomputer, a substrate, and the like can be arranged, for example, inside the power converter 7.

The operator 20 that is operable by an occupant is an operation panel of a so-called car air conditioner and accepts instructions to perform temperature setting for the vehicle compartment 2, switching between internal air circulation and outside air intake, switching of air outlets, and the like. The SOC acquirer 21 acquires the remaining capacity (SOC: state of charge) of the battery B by measuring the charge/discharge current and cell voltage of the battery B, and the battery temperature sensor 22 detects temperature of the battery B.

The circuits shown in FIG. 2 include, in addition to a plurality of temperature sensors for detecting temperatures of the flow channels, a rotational speed sensor for the compressor 30, a vehicle compartment temperature sensor, an outside air temperature sensor, and the like. The controller 23 controls the heat pump circuit 24, the temperature control circuit 25, and the battery temperature control circuit 26 based on, in addition to the content of an operation on the operator 20, output signals of the various kinds of sensors including the battery temperature sensor 22. With regard to air conditioning of the vehicle compartment 2, the controller 23 can execute, in switchable manner, operation modes including heating operation, dehumidifying and heating operation, cooling operation, dehumidifying and cooling operation, and the like.

The controller 23 performs drive control of each of the compressor 30, the heating expansion valve 37, the low-pressure solenoid valve 33, the high-pressure solenoid valve 38, and the cooling expansion valve 35 that constitute the heat pump circuit 24. Further, the controller 23 performs drive control of each of the water pump 41 and the water heater 43 that constitute the temperature control circuit 25. Furthermore, the controller 23 performs drive control of the battery temperature control expansion valve 39 according to a state of the battery B, such as the temperature or the like.

Here, it becomes necessary for the electric vehicle 1, which drives the motor M with power of the battery B to travel, to discard (consume) excess electricity in order to avoid overcharging of the battery B due to regenerative power generation at the time of descending, decelerating, or the like. To cope with this, power consumption is increased by causing a temperature control circuit capable of performing heating operation with a heater to work in the known art. There is, however, a problem that the electricity waste operation performance depends on the performance of the temperature control circuit, and the amount of electricity that can be discarded is limited.

In contrast, the vehicle air conditioning apparatus 50 according to the present embodiment has a feature in which, when a remaining capacity SOC of the battery B exceeds a predetermined threshold th, it performs heating operation by the temperature control circuit 25 including the water heater 43 and operates the heat pump circuit 24 including the heat pump in a defrosting mode to enhance the electricity waste operation capability of the whole system.

Here, the defrosting mode is an operation mode for melting and removing (defrosting) frost on the external heat exchanger 32 of the heat pump circuit 24. Formation of frost on the external heat exchanger 32 occurs, for example, when heating operation is performed under an atmosphere with an outside air temperature of 5° C. or below and a humidity of 70% or above. This is because an area around the external heat exchanger 32 that functions as an evaporator during heating operation is cooled, and moisture in the air is solidified. The frost forming on the external heat exchanger 32 reduces the heat exchange efficiency, and the heating effect is reduced. Therefore, defrosting is appropriately performed by operation in the defrosting mode.

In the defrosting mode according to the present embodiment, the temperature of the air conditioning refrigerant flowing through the first flow channel 51 of the heat pump circuit 24 is made higher than the outside air temperature, and the air conditioning refrigerant circulates via the compressor 30, the water-cooled condenser 42, the heating expansion valve 37, the external heat exchanger 32, the low-pressure solenoid valve 33, and the accumulator 31 in this order. When this circulation route is used in the normal defrosting mode, it is necessary to control the refrigerant temperature to be higher than the outside air temperature because desired defrosting cannot be performed unless the external heat exchanger 32 is used as a radiator. Therefore, at the water-cooled condenser 42, a temperature difference between the air conditioning refrigerant flowing through the first flow channel 51 and the temperature control circuit 25 is important, and the temperature of the temperature control circuit 25 has to be higher than the refrigerant circuit so that heat is not transferred from the refrigerant circuit to the temperature control circuit 25. However, this is not always necessary for the electricity waste operation of the present embodiment because it is only necessary to discard electricity. The electricity waste operation of the present embodiment is achieved by the controller 23 controlling the water heater 43, the compressor 30, and the heating expansion valve 37. The gas-phase air conditioning refrigerant is compressed by the compressor 30, and as a result, comes to have a high temperature. The air conditioning refrigerant passes through the water-cooled condenser 42, and then is expanded at the heating expansion valve 37 so as to have a high temperature and a low pressure. However, since the controller 23 performs control to make the refrigerant temperature higher than the outside air temperature by means of the external heat exchanger 32, air conditioning refrigerant dissipates heat. After that, the refrigerant circulates via the low-pressure solenoid valve 33 and the accumulator 31 in this order. At this time, the refrigerant is caused to exchange heat with the temperature control circuit 25 in the water-cooled condenser 42. By driving the water pump 41 of the temperature control circuit 25, the heat transfer medium flows, and the vehicle compartment is heated by the heater core 44. In the defrosting mode, the external heat exchanger 32 exchanges heat with the outdoor air by means of a blower fan (an HVAC blower; not shown). A blower fan that blows air into the vehicle compartment 2 does not blow the air to the external heat exchanger 32 but to the heater core 44 and the evaporator 34. Normal heating is possible without stopping the blower fan that blows air into the vehicle compartment 2. A radiator fan that blows air passing through the external heat exchanger 32 is stopped at the time of defrosting but, at the time of performing the present electricity waste operation, is not stopped so as to promote heat radiation by the external heat exchanger 32. The opening degree of the heating expansion valve 37 and the temperature set for the air conditioning refrigerant in the defrosting mode can be variously changed. Furthermore, by adjusting the heating expansion valve 37 so that the refrigerant temperature of the water-cooled condenser 42 is made lower than the heat transfer medium temperature of the water-cooled condenser 42, heat of a heating hot-water circuit can be radiated to the outside of the vehicle, and the ECH 43 can consume (discard) more power than the power required for heating.

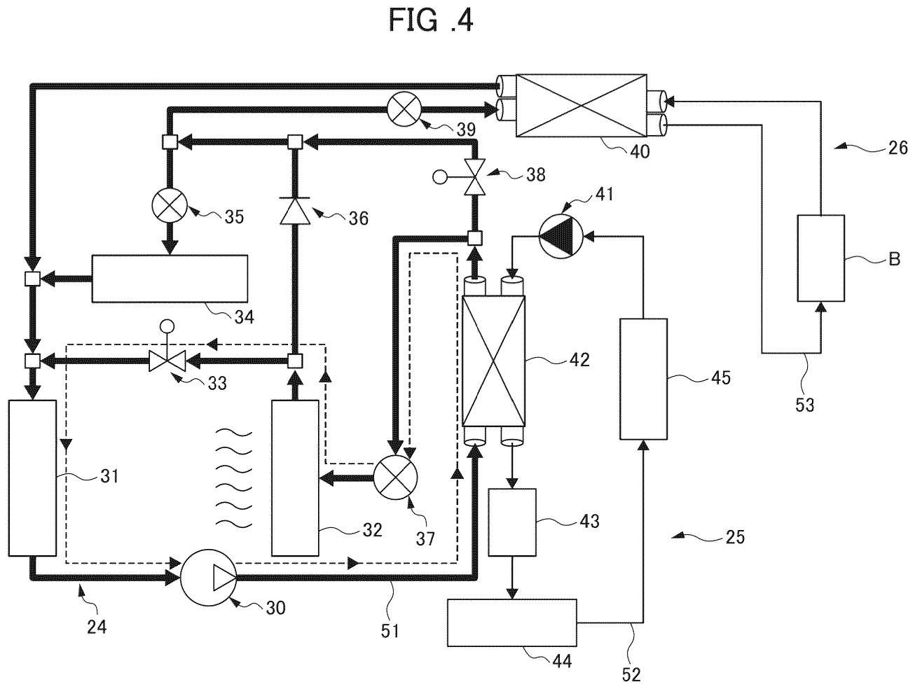

FIG. 4 is a circuit diagram showing a state of heating operation in the case of the remaining capacity SOC of the battery B being equal to or below the predetermined threshold th. When the remaining capacity SOC of the battery B is equal to or below the predetermined threshold th, heating operation is in principle performed only by the energy-efficient heat pump circuit 24. When the heating capability is insufficient, however, it is possible to cause the temperature control circuit 25, which is a so-called auxiliary heating system, to work together.

In the case of performing heating operation by the heat pump circuit 24, the controller 23 drives the compressor 30 in a state of the heating expansion valve 37 being slightly open, the low-pressure solenoid valve 33 being open, and the high-pressure solenoid valve 38, the cooling expansion valve 35, and the battery temperature control expansion valve 39 being closed.

Thereby, the air conditioning refrigerant circulates via the compressor 30, the water-cooled condenser 42, the heating expansion valve 37, the external heat exchanger 32, the low-pressure solenoid valve 33, and the accumulator 31 in this order. Through this circulation route, the gas-phase air conditioning refrigerant is compressed by the compressor 30, so as to have a high temperature. Thereafter, the air conditioning refrigerant is caused to exchange heat with the temperature control circuit 25 in the water-cooled condenser 42, and the vehicle compartment 2 is heated by the heater core 44. At that time, the air conditioning refrigerant is changed into the liquid phase in the water-cooled condenser 42. Thereafter, the air conditioning refrigerant is expanded by the heating expansion valve 37 so as to have a low temperature and a low pressure, and the refrigerant evaporates. The low-temperature and low-pressure refrigerant absorbs heat as evaporation heat at the external heat exchanger 32, and the refrigerant temperature increases to be approximately equal to the outside air temperature. The refrigerant then circulates via the low-pressure solenoid valve 33 and the accumulator 31 in this order.

In the case of performing dehumidifying and heating operation by the heat pump circuit 24, the compressor 30 is driven in a state of the heating expansion valve 37 being slightly open, the low-pressure solenoid valve 33 being open, the cooling expansion valve 35 being slightly open, and the battery temperature control expansion valve 39 being closed.

Thereby, the air conditioning refrigerant circulates via the compressor 30, the water-cooled condenser 42, the heating expansion valve 37, the external heat exchanger 32, the low-pressure solenoid valve 33, and the accumulator 31 in this order, and the air conditioning refrigerant passing through the check valve 36 circulates via the cooling expansion valve 35 and the evaporator 34. The liquid-phase air conditioning refrigerant that has passed through the check valve 36 is expanded by the cooling expansion valve 35 so as to have a low pressure, and evaporates due to heat absorption by the evaporator 34. As a result, the air dehumidified by the evaporator 34 is heated by the heater core 44, and it becomes possible to supply the dehumidified warm air to the vehicle compartment 2.

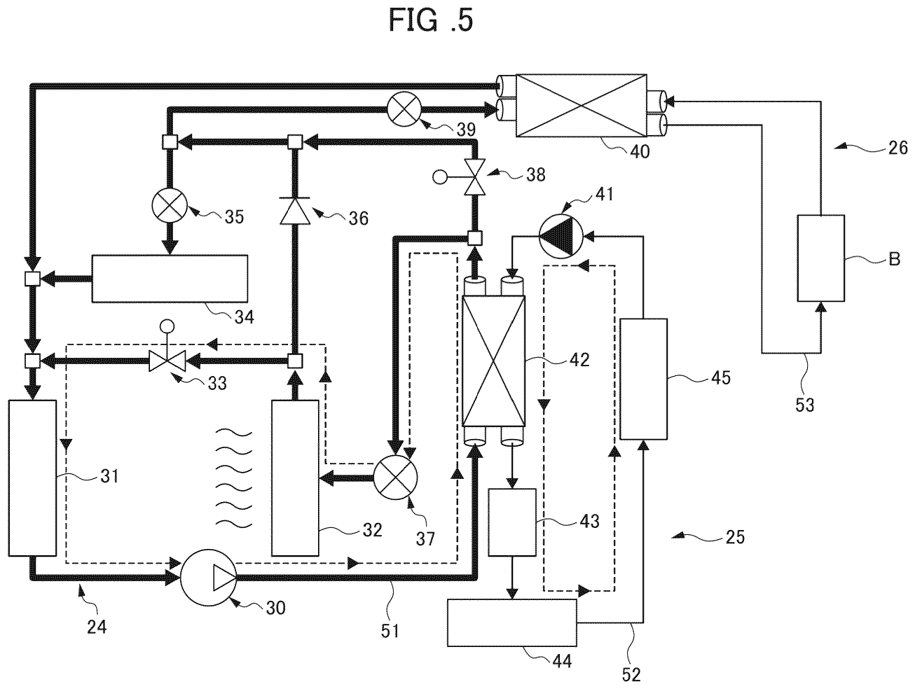

FIG. 5 is a circuit diagram showing a state of heating operation in the case of the remaining capacity SOC of the battery B exceeding the predetermined threshold th. When the remaining capacity SOC of the battery B exceeds the predetermined threshold th, the controller 23 starts heating operation by the temperature control circuit 25 as the second air conditioning system and operates the heat pump circuit 24 as the first air conditioning system in the defrosting mode.

The heating operation by the temperature control circuit 25 is performed by causing the water heater 43 and the water pump 41 to work. Thereby, air is heated by the heater core 44, and it becomes possible to supply the warm air to the vehicle compartment 2. Meanwhile, in the heat pump circuit 24, operation in the defrosting mode is performed. As described before, in the defrosting mode, the temperature of the air conditioning refrigerant flowing through the first flow channel 51 of the heat pump circuit 24 is made higher than the outside air temperature, and the compressor 30 is caused to work in the state in which the opening degree of the heating expansion valve 37 is fixed to a predetermined opening degree that is slightly open from the closed state.

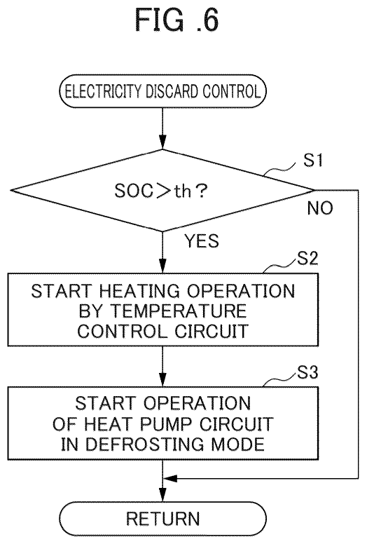

FIG. 6 is a flowchart showing a flow of the electricity waste operation control according to the present embodiment. The electricity waste operation control is executed as timer interrupt processing at predetermined time intervals. In Step S1, it is determined whether the remaining capacity SOC of the battery B has exceeded the predetermined threshold th or not. The predetermined threshold th can be set, for example, to 90%. When a positive determination is made, that is, it is determined that the remaining capacity SOC of the battery B has exceeded the predetermined threshold th in Step S1, the flow proceeds to Step S2 on the assumption that it is not preferable to perform further regenerative charging. On the other hand, if a negative determination is made, that is, the remaining capacity SOC of the battery B is equal to or below the predetermined threshold th in Step S1, the control sequence ends on the assumption that regenerative charging is still possible.

In Step S2, heating operation by the temperature control circuit 25 is started, and, in the subsequent Step S3, operation of the heat pump circuit 24 in the defrosting mode is started. In this way, it becomes possible to perform electricity waste operation while performing heating operation and thereby avoid overcharging of the battery B. Furthermore, by not only causing the temperature control circuit 25 including the water heater 43 to work but also operating the heat pump circuit 24 including the heat pump in the defrosting mode, it is possible to enhance the electricity waste operation capability of the whole system.

When the remaining capacity SOC of the battery B exceeds the predetermined threshold th during heating operation by the heat pump circuit 24, the controller 23 executes control to switch from the heating operation by the heat pump circuit 24 to heating operation by the temperature control circuit 25. Thus, it becomes possible to, when the remaining capacity SOC of the battery B is equal to or below the predetermined threshold th, save electricity by the energy-efficient heating operation using the heat pump circuit 24. In other words, only when the remaining capacity SOC of the battery B exceeds the predetermined threshold th, it becomes possible to switch to the inefficient operation by the temperature control circuit 25 to thereby enhance the electricity waste operation capability.

The form of the electric vehicle, flow channel configurations of the heat pump circuit and the temperature control circuit, structures of the compressor, the heater, the heat exchanger, and the expansion valve, and the like are not limited to those of the above embodiment, and various changes may be made. For example, the heat pump circuit may include an indoor air-cooled condenser or may include a circuit that not only cools the battery but also warms the battery. The vehicle air conditioning apparatus according to the present invention is applicable not only to an electric automobile that drives the motor with power of a battery to travel, but also to various vehicles such as a hybrid vehicle and a fuel cell vehicle.

### EXPLANATION OF REFERENCE NUMERALS

1: electric vehicle (vehicle)
23: controller
24: first air conditioning system (heat pump circuit)
25: second air conditioning system (temperature control circuit)
37: heating expansion valve
43: heater
50: vehicle air conditioning apparatus
51: first flow channel (flow channel)
M: motor
B: battery
SOC: battery remaining capacity
th: predetermined threshold

What is claimed is:

1. A vehicle air conditioning apparatus comprising:
a first air conditioning system capable of performing heating operation using a heat pump;
a second air conditioning system capable of performing heating operation using a heater; and
a controller configured to control at least the first air conditioning system and the second air conditioning system, wherein
when a remaining capacity of a battery that supplies power to a motor of a vehicle exceeds a predetermined threshold, the controller performs the heating operation by the second air conditioning system and operates the first air conditioning system in a defrosting mode.

2. The vehicle air conditioning apparatus according to claim 1, wherein
when the remaining capacity of the battery exceeds the predetermined threshold during the heating operation by the first air conditioning system, the controller switches from the heating operation by the first air conditioning system to the heating operation by the second air conditioning system.

3. A vehicle air conditioning apparatus comprising:
a first air conditioning system capable of performing heating operation using a heat pump;
a second air conditioning system capable of performing heating operation using a heater; and
a controller configured to control at least the first air conditioning system and the second air conditioning system, wherein
when a remaining capacity of a battery that supplies power to a motor of a vehicle exceeds a predetermined threshold, the controller performs the heating operation by the second air conditioning system and operates the first air conditioning system in a defrosting mode,
the defrosting mode is an operation mode in which temperature of an external heat exchanger for air conditioning refrigerant flowing through a flow channel of the first air conditioning system is made higher than outside air temperature, and the air conditioning refrigerant is cycled in a gaseous state by fixing a heating expansion valve of the first air conditioning system to a predetermined opening degree and driving a compressor.

4. A vehicle air conditioning apparatus comprising:
a first air conditioning system capable of performing heating operation using a heat pump;
a second air conditioning system capable of performing heating operation using a heater; and
a controller configured to control at least the first air conditioning system and the second air conditioning system, wherein
when a remaining capacity of a battery that supplies power to a motor of a vehicle exceeds a predetermined threshold, the controller performs the heating operation by the second air conditioning system and operates the first air conditioning system in a defrosting mode,
when the remaining capacity of the battery exceeds the predetermined threshold during the heating operation by the first air conditioning system, the controller switches from the heating operation by the first air conditioning system to the heating operation by the second air conditioning system,
the defrosting mode is an operation mode in which temperature of an external heat exchanger for air conditioning refrigerant flowing through a flow channel of the first air conditioning system is made higher than outside air temperature, and the air conditioning refrigerant is cycled in a gaseous state by fixing a heating expansion valve of the first air conditioning system to a predetermined opening degree and driving a compressor.

5. A vehicle air conditioning apparatus comprising:
a first air conditioning system capable of performing heating operation using a heat pump;
a second air conditioning system capable of performing heating operation using a heater; and
a controller configured to control at least the first air conditioning system and the second air conditioning system, wherein
when a remaining capacity of a battery that supplies power to a motor of a vehicle exceeds a predetermined threshold, the controller performs the heating operation by the second air conditioning system and operates the first air conditioning system in a defrosting mode,
the defrosting mode is an operation mode in which temperature of an external heat exchanger for air conditioning refrigerant flowing through a flow channel of the first air conditioning system is made higher than outside air temperature, and the air conditioning refrigerant is cycled in a gaseous state by fixing a heating expansion valve of the first air conditioning system to a predetermined opening degree and driving a compressor,
the predetermined opening degree of the heating expansion valve in the defrosting mode is a low opening degree close to a closed state.

6. A vehicle air conditioning apparatus comprising:
a first air conditioning system capable of performing heating operation using a heat pump;
a second air conditioning system capable of performing heating operation using a heater; and
a controller configured to control at least the first air conditioning system and the second air conditioning system, wherein
when a remaining capacity of a battery that supplies power to a motor of a vehicle exceeds a predetermined threshold, the controller performs the heating operation by the second air conditioning system and operates the first air conditioning system in a defrosting mode,
when the remaining capacity of the battery exceeds the predetermined threshold during the heating operation by the first air conditioning system, the controller switches from the heating operation by the first air conditioning system to the heating operation by the second air conditioning system.
the defrosting mode is an operation mode in which temperature of an external heat exchanger for air conditioning refrigerant flowing through a flow channel of the first air conditioning system is made higher than outside air temperature, and the air conditioning refrigerant is cycled in a gaseous state by fixing a heating expansion valve of the first air conditioning system to a predetermined opening degree and driving a compressor,
the predetermined opening degree of the heating expansion valve in the defrosting mode is a low opening degree close to a closed state.
